(19) United States
(12) Patent Application Publication
(10) Pub. No.: US 2013/0176436 A1
(43) Pub. Date: Jul. 11, 2013

(54) Image Capturing Device Applied in Vehicle and Image Superimposition Method Thereof

(71) Applicants: Che-Hung Lin, Puli Township (TW); Chung-Fang Chien, Taipei City (TW)

(72) Inventors: Che-Hung Lin, Puli Township (TW); Chung-Fang Chien, Taipei City (TW)

(73) Assignee: ALTEK AUTOTRONICS CORP., Hsinchu (TW)

(21) Appl. No.: 13/407,255

(22) Filed: Feb. 28, 2012

(30) Foreign Application Priority Data
Jan. 9, 2012 (TW) 101100777

(51) Int. Cl. H04N 7/18

(52) U.S. Cl. 348/148; 348/E07.085

(57) ABSTRACT

An image capturing device applied in a vehicle and an image superimposition method thereof. The image capturing device comprises an image capturing module, a processing module and an image superimposition module. The processing module dynamically controls a sampling time of a plurality of temporary images captured by the image capturing module according to driving information of the vehicle. The image superimposition module superimposes feature regions in the temporary images to produce at least one superimposed image based on the driving information of the vehicle.

### CROSS-REFERENCE TO RELATED APPLICATION

This application claims the benefit of Taiwan Patent Application No. 101100777, filed on Jan. 9, 2012, in the Taiwan Intellectual Property Office, the disclosure of which is incorporated herein in its entirety by reference.

### BACKGROUND OF THE INVENTION

1. Field of the Invention

The present invention relates to an image capturing device and an image superimposition method thereof, and more particularly to the image capturing device applied in a vehicle and the image superimposition method thereof.

2. Description of Related Art

Present reverse image sensors available in the market are analog sensors of the National Television Standards Committee (NTSC), which are limited by the specification of the NTSC TV Signal with an output of 60 fields per second, and the maximum exposure time of the NTSC analog sensor is only 1/60 second. With the limitation of the exposure time, a general technology simply enhances image brightness simply by adjusting the gain of the sensors to improve the light sensitivity of a low illumination.

The driving recorders are digital sensors with a general image output limited to 30 frames per second. With the limitation of the exposure time, a general technology simply enhances image brightness simply by adjusting the gain of the sensors to improve the light sensitivity of a low illumination.

The digital sensor with the output frequency modulation function can change the maximum exposure time from 1/15 second to double the exposure time by adjusting the image output frequency (to 15 frames for example).

Wherein, the digital sensor is better than the analog sensor, since the exposure time of a low illumination can adjust the exposure time of the low illumination to a longer exposure time to improve the light sensitivity of the low illumination, but it is inappropriate to decrease the number of frames per second too much which will result in an insufficient image smoothness. When a dynamic scene is taken, the increased exposure time will cause a motion blur to the dynamic scene.

However, the light sensitivity of the image can be improved by increasing the gain of the sensor, regardless of using a digital or analog sensor, and a noise of the image will be amplified in the same time. If the numeric value of the signal to noise ratio (SNR) is too low and the gain of the sensor is too large, viewers may have a poor recognition to the image signals, and a snowflake signal is generated. Therefore, the increased gain of the sensor cannot enhance the light sensitivity effectively.

Regardless of an image pickup system using the fixed exposure time or the variable exposure time, a long-time exposure generally causes an image blur in a low illumination environment, since image of a short-time exposure has lots of noises. Particularly, a motor vehicle is usually in motion, a longer-time exposure is not feasible.

In addition, when the motor vehicle is driven on a road without road lamps or parked in a parking lot with insufficient light, the illumination is extremely insufficient, the image will be too dark or lots of noises will occur, and it is difficult to recognize the surrounding environment, regardless of viewing the image visually, or by accessory sight glasses or cameras.

### SUMMARY OF THE INVENTION

In view of the aforementioned shortcomings of the prior art, it is a primary objective of the invention to provide an image capturing device applied in a vehicle and an image superimposition method thereof to overcome the problems of having many noises caused by a short-time exposure or an image blur caused by a long-time exposure, regardless of using an image pickup system with a fixed exposure time or a variable exposure time in a moving car.

To achieve the foregoing objective, the present invention provides an image capturing device applied in a vehicle, comprising an image capturing module, a processing module and an image superimposition module. The processing module is provided for dynamically controlling a sampling time of a plurality of temporary images captured by the image capturing module according to driving information of the vehicle. The image superimposition module is provided for superimposing feature regions in the temporary images to generate at least one superimposed image, if the driving information of the vehicle matches a preset condition.

Wherein, the driving information comprises a driving direction of the vehicle, a U-turn angle of a steering wheel, a driving speed, a shift gear or a position datum of global positioning system (GPS).

Wherein, the preset condition comprises the driving speed being less than a predetermined speed, or the U-turn angle being greater than a predetermined angle, or the shift gear being a reverse gear.

Wherein, the processing module correspondingly shortens or extends the sampling time of each temporary image according to an increase or a decrease of a driving speed of the vehicle.

Wherein, the image capturing device further comprises a setting module for setting a plurality of time intervals, and the processing module correspondingly controls to turn on or off a light sensor of the image capturing device according to the time intervals or an ON or OFF state of an illumination device of the vehicle.

Wherein, the image capturing device further comprises a receiving module, for receiving radar information, and the image superimposition module is provided for superimposing the feature regions in the temporary images to generate the at least one superimposed image according to the radar information.

Wherein, the similar feature regions comprise a lane, a scene or an object.

To achieve the foregoing objective, the present invention further provides an image superimposition method applied in a vehicle, comprising the steps of: installing an image capturing module; using a processing module to dynamically control a sampling time of a plurality of temporary images captured by the image capturing module according to driving information of the vehicle; and using an image superimposition module to superimpose the feature regions in the temporary images to generate at least one superimposed image if the driving information of the vehicle matches a preset condition.

Wherein, the image superimposition method further comprises the steps of: using a setting module to set a plurality of time intervals; and using the processing module to correspondingly control to turn on or off a light sensor of the image capturing device according to the time intervals or an ON or OFF state of an illumination device of the vehicle.

Wherein, the image superimposition method further comprises the steps of using a receiving module to receive radar information; and superimposing the feature regions in the temporary images according to the radar information to produce the at least one superimposed image by the image superimposition module.

Wherein, the feature regions comprise a lane, a scene or an object.

Wherein, the image superimposition method further comprises the step of shortening or extending the sampling time of each temporary image according to an increase or a decrease of a driving speed of the vehicle.

Wherein, the driving information comprises a driving direction of the vehicle, a U-turn angle of a steering wheel, a driving speed, a shift gear or a position datum of global positioning system (GPS).

Wherein, the preset condition comprises the driving speed being less than a predetermined speed, or the U-turn angle being greater than a predetermined angle, or the shift gear being a reverse gear.

To achieve the foregoing objective, the present invention further provides an image capturing device applied in a vehicle, comprising: an image capturing module; a receiving module, for receiving radar information; a setting module, for setting a plurality of time intervals; a processing module, dynamically controlling a sampling time of a plurality of temporary images captured by the image capturing module according to driving information of the vehicle and the radar information, and turning on or off an illumination device according to the time intervals or the vehicle to correspondingly control a light sensor to turn on or off a light sensor of the image capturing device; and an image superimposition module, for superimposing feature regions in the temporary images to generate at least one superimposed image, if the driving information of the vehicle matches a preset condition and the radar information.

Wherein, the driving information comprises a driving direction of the vehicle, a U-turn angle of a steering wheel, a driving speed, a shift gear or a position datum of global positioning system (GPS).

Wherein, the preset condition comprises the driving speed being less than a predetermined speed, or the U-turn angle being greater than a predetermined angle, or the shift gear being a reverse gear.

Wherein, the processing module correspondingly shortens or extends the sampling time of each temporary image according to an increase or a decrease of a driving speed of the vehicle.

In summation of the description above, the image capturing device applied in a vehicle and the image superimposition method thereof in accordance with the present invention have the following advantage:

The image capturing device applied in a vehicle and the image superimposition method thereof can reference the driving information and use two or more temporary images for comparing the feature regions in the temporary images, and then superimpose images at a fixed point of the same area to improve the noises of the images and the brightness of the images.

### BRIEF DESCRIPTION OF THE DRAWINGS

FIG. 1 is a block diagram of an image capturing device applied in a vehicle in accordance with a first preferred embodiment of the present invention;

FIG. 2 is a flow chart of an image superimposition method applied in a vehicle in accordance with the first preferred embodiment of the present invention;

FIG. 3 is a first schematic view of an image capturing device applied in a vehicle in accordance with the first preferred embodiment of the present invention;

FIG. 4 is a second schematic view of an image capturing device applied in a vehicle in accordance with the first preferred embodiment of the present invention;

FIG. 5 is a block diagram of an image capturing device applied in a vehicle in accordance with a second preferred embodiment of the present invention; and

FIG. 6 is a flow chart of an image superimposition method applied in a vehicle in accordance with the second preferred embodiment of the present invention.

### DETAILED DESCRIPTION OF THE PREFERRED EMBODIMENTS

The technical contents and characteristics of the image capturing device and its image processing method in accordance with the present invention will be apparent with the detailed description of a preferred embodiment accompanied with related drawings as follows. For simplicity, same numerals are used in the following preferred embodiment to represent respective same elements.

The image capturing device of the present invention is applied to a vehicle which can be a motorcycle, a car, or a truck, and the image capturing device can be a car camera, a driving recorder, a reverse image sensor, a digital video camera, or any electronic device with an image pickup function. To make it easier to understand the technical characteristics of the present invention, the embodiment of a car camera installed in a car is used for illustrating the present invention, but the invention is not limited to this embodiment only.

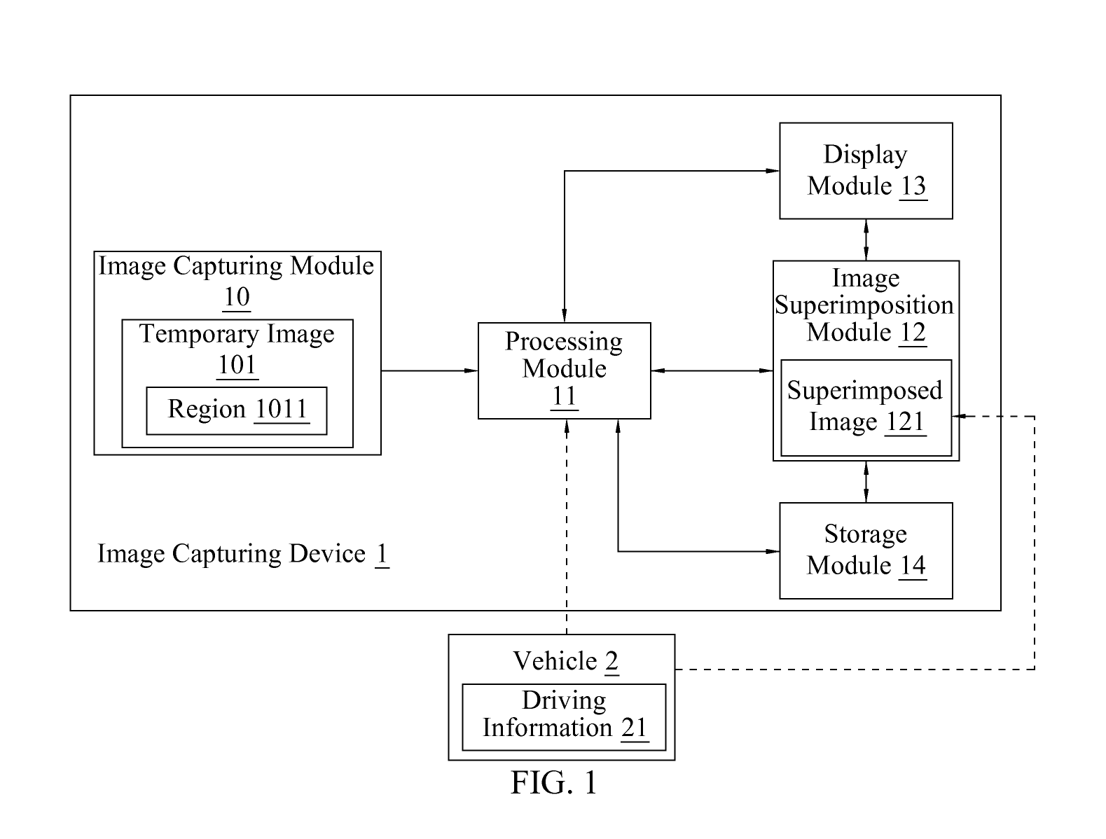

With reference to FIG. 1 for a block diagram of an image capturing device applied in a vehicle in accordance with the first preferred embodiment of the present invention, the image capturing device 1 comprises an image capturing module 10, a processing module 11, an image superimposition module 12, a display module 13 and a storage module 14. The image capturing module 10 comprises a lens, a sensor such as a Complementary Metal Oxide Semiconductor (CMOS) or a Charge Coupled Device (CCD), an analog/digital circuit, and an image processor, etc.

The processing module 11 is electrically coupled to the image capturing module 10, the image superimposition module 12, the display module 13 and the storage module 14, and the processing module 11 can be a Central Processing Unit (CPU) or a micro-processing unit. The processing module 11 is provided for dynamically controlling a sampling time of a plurality of temporary images 101 captured by the image capturing module 10 according to driving information 21 of the vehicle 2. Preferably, the driving information 21 can comprises a driving direction of a car, a U-turn angle of a steering wheel, a driving speed, a shift gear or a Global Positioning System (GPS). The image superimposition module 12 is provided for superimposing feature regions 1011 (such as a lane, a scene or an object) in the temporary images 101 to generate at least one superimposed image 121 if the driving information 21 of the vehicle 2 matches a preset condition. Wherein, the preset condition can comprise a driving speed less than a predetermined speed, or a U-turn angle greater than a predetermined angle, or a shift gear which is a reverse gear.

The processing module 11 can then transmit at least one superimposed image 121 to the display module 13, or control the image superimposition module 12 to transmit at least one superimposed image 121 to the display module 13 for displaying the superimposed image 121. In addition, the processing module 11 can save at least one superimposed image 121 in the storage module 14, or control the image superimposition module 12 to save at least one superimposed image 121 in the storage module 14.

In the description above, the processing module 11 can shorten or extend the length of the sampling time of each temporary image 101 according to an increase or a decrease of the driving speed of the vehicle 2.

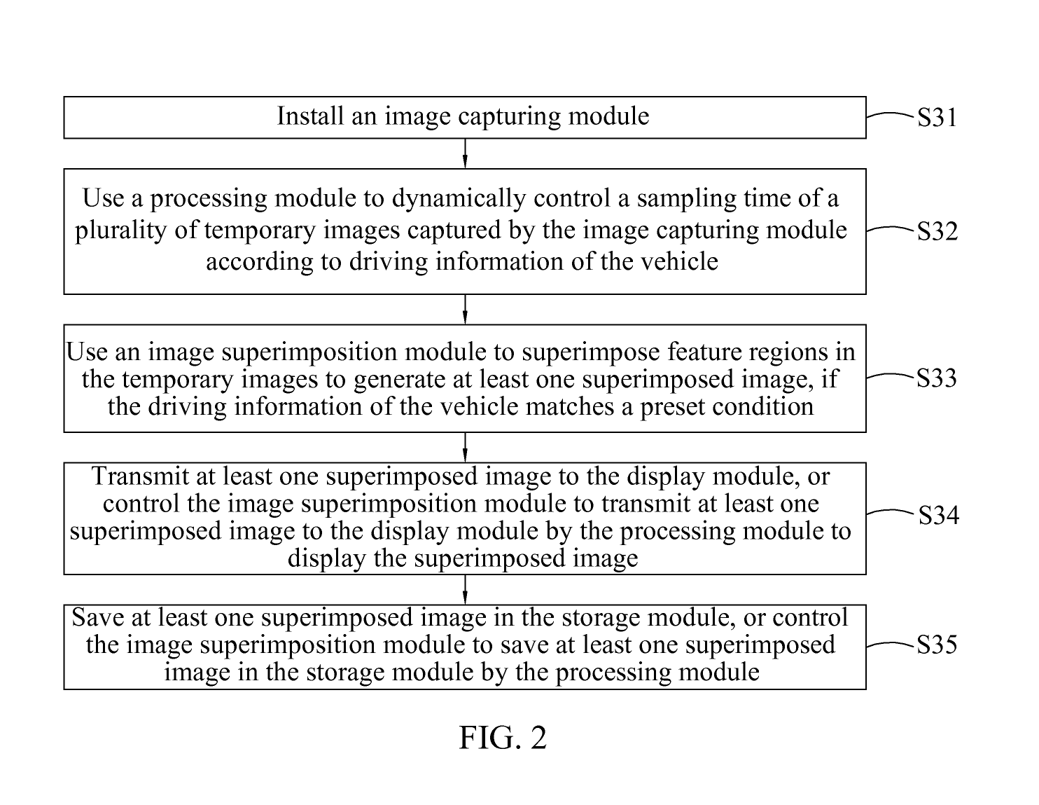

With reference to FIG. 2 for a flow chart of an image superimposition method applied in a vehicle in accordance with the first preferred embodiment of the present invention together with FIG. 1, an image capturing device comprises an image capturing module, a processing module and an image superimposition module. The image superimposition method applied in an image capturing device comprises the following steps:
(S31) Install an image capturing module.
(S32) Use a processing module to dynamically control a sampling time of a plurality of temporary images captured by the image capturing module according to driving information of the vehicle.
(S33) Use an image superimposition module to superimpose similar feature regions in the temporary images to generate at least one superimposed image, if the driving information of the vehicle matches a preset condition.
(S34) Transmit at least one superimposed image to the display module, or control the image superimposition module to transmit at least one superimposed image to the display module by the processing module to display the superimposed image.
(S35) Finally, save at least one superimposed image in the storage module, or control the image superimposition module to save at least one superimposed image in the storage module by the processing module.

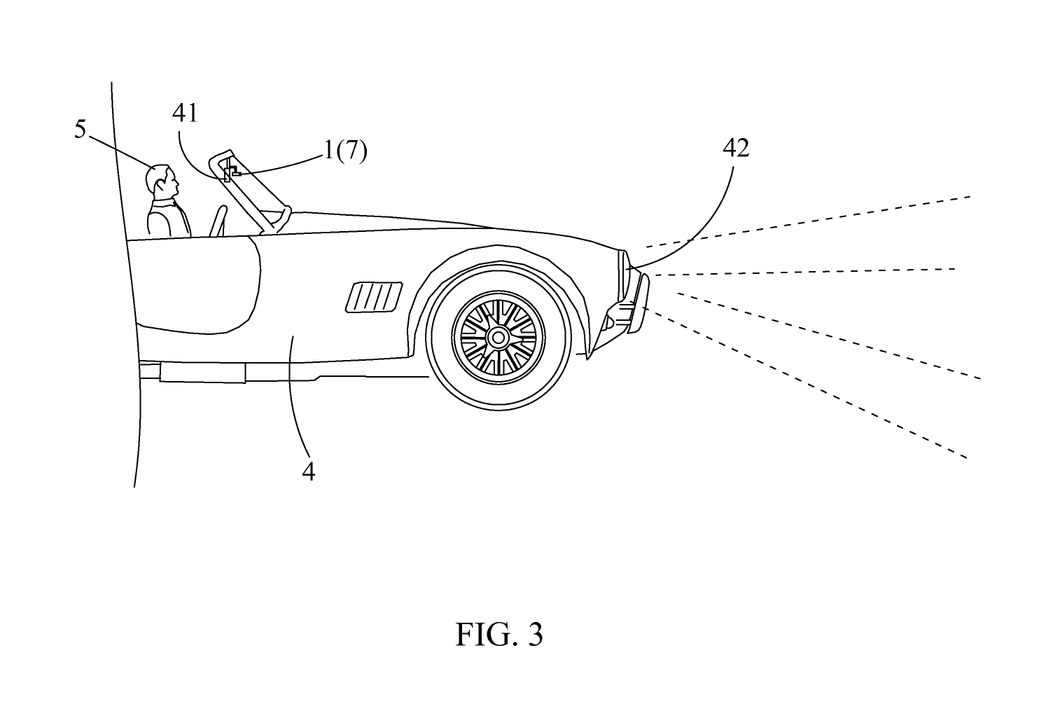

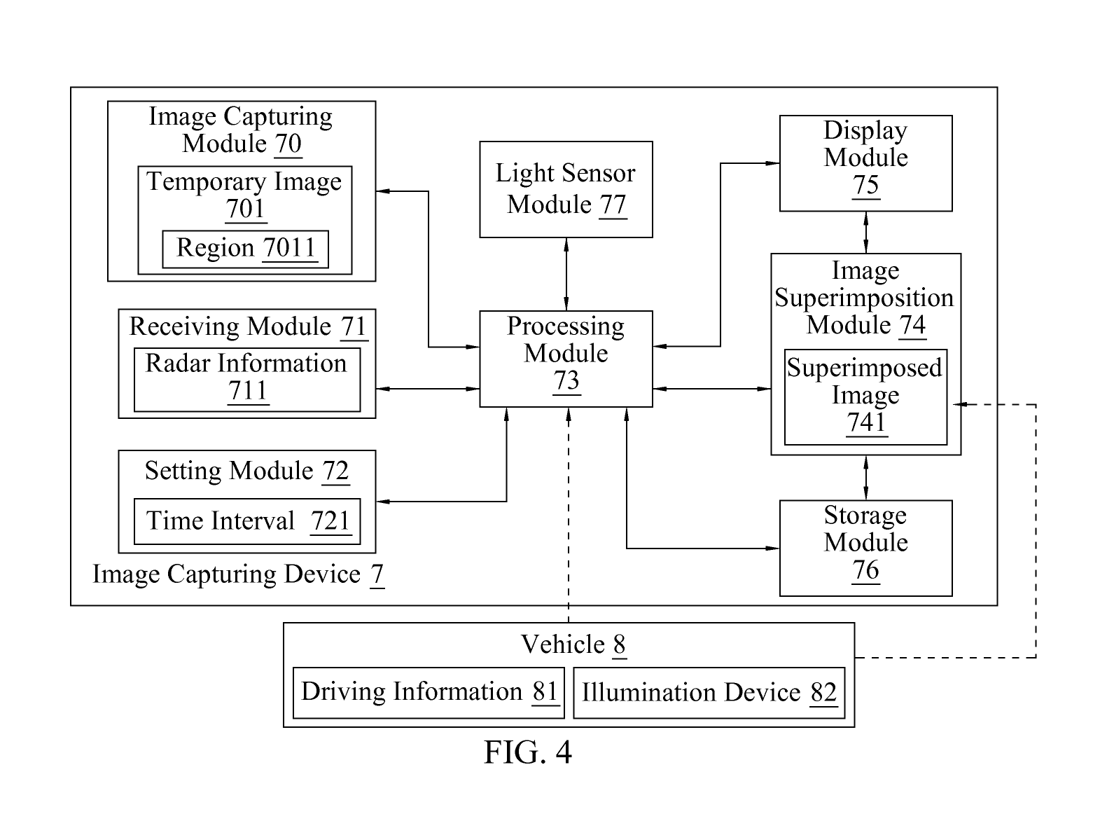

With reference to FIGS. 3 and 4 for first and second schematic views of an image capturing device applied in a vehicle in accordance with the first preferred embodiment of the present invention respectively together with FIG. 1, the image capturing device 1 is installed in a car 4, and the installation position of the image capturing device 1 depends on the preference of a driver 5. In this preferred embodiment, the image capturing device 1 is installed under a rearview mirror 41, but the invention is not limited to such arrangement only. When the car 3 is driven in an environment of a low illumination, the image capturing device 1 can receive driving information 21 such as a driving direction of the mobile vehicle, a U-turn angle of a steering wheel, a driving speed, a shift gear or a position datum of global positioning system (GPS) through the processing module 11. The processing module 11 can dynamically control a sampling time of a plurality of temporary images 101 captured by the image capturing module 10 according to driving speed of the vehicle.

In other words, if the driving speed of the car 4 is higher than a predetermined value, the processing module 11 can reduce the sampling time of the plurality of temporary images 101 captured by the image capturing module 10. If the driving speed of the car 4 is less than the predetermined value, the processing module 11 can control the image capturing module 10 to extend the sampling time. In addition, the predetermined value can be set by the driver 5, or the image capturing device 1 is configured with a factory default setting.

After the image capturing module 10 captures a plurality of temporary images 101, the processing module 11 transmits the temporary images 101 to the image superimposition module 12, and the image superimposition module 12 will select a reference temporary image 61 from the temporary images 101 with a better image quality, and if related information of the position data comprising the driving direction of the car 4, the U-turn angle of the steering wheel, the driving speed, the shift gear or the Global Positioning System (GPS) matches a preset condition, such as the U-turn angle of the steering wheel being greater than a predetermined angle, then an image superimposition is performed for each pixel of a lane, a scene or an object with similar features in the temporary images 101 to generate at least one superimposed image 121.

For example, when the driver 5 is driving at a driving speed greater than 20 km/hr in an environment with low illumination, the processing module 11 can shorten the sampling time for the image capturing module 10 to capture the temporary image 101 from 1/50 second to 1/100 second, and take several clearer temporary images 101, and use the image superimposition module 12 to superimpose the temporary images to generate a superimposed image 121, so as to reduce the noises of the images and avoid a too-long sampling time that may cause an image blur.

More specifically, the processing module 11 transmits the temporary image 101 captured by the image capturing module 10 to the image superimposition module 12. When the image superimposition module 12 references the angle of turning the steering wheel of the car 4 to the right or the left which is greater than a predetermined angle (such as 60°), the image superimposition module 12 performs an image superimposition for each pixel of a lane, a car in the front, or a tree with similar features in the temporary images 101 to generate at least one superimposed image 121. Further, in this preferred embodiment, the processing module 11 can enhance the brightness of the superimposed image 121 and remove the noises. It is noteworthy to point out that the aforementioned embodiments are provided for the purpose of illustrating the present invention only, but not intended for limiting the scope of the invention.

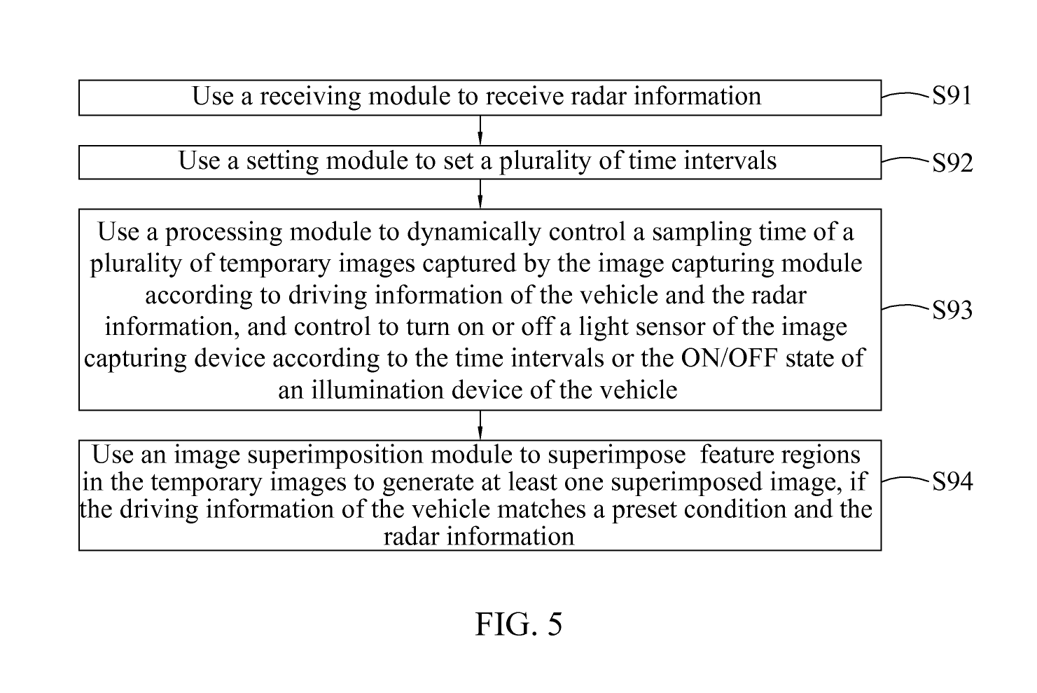

With reference to FIG. 5 for a block diagram of an image capturing device applied in a vehicle in accordance with the second preferred embodiment of the present invention together with FIG. 3, the image capturing device 7 comprises an image capturing module 70, a receiving module 71, a setting module 72, a processing module 73, an image superimposition module 74, a display module 75 and a storage module 76. The receiving module 71 is provided for receiving radar information 711, wherein the operation method of the image capturing module 70, the display module 75 and the storage module 76 are similar to those of the first preferred embodiment, and thus will not be described. However, it is noteworthy to point out that the receiving module 71 of this preferred embodiment can receive the radar information 711, and the setting module 72 can be used to set the plurality of time intervals 721, such as setting two time intervals to 12 hours each.

The processing module 73 is electrically coupled to the image capturing module 70, the receiving module 71, the setting module 72, the image superimposition module 74, the display module 75 and the storage module 76. The processing module 73 also can be used for dynamically controlling a sampling time of a plurality of temporary images 701 captured by the image capturing module 70 according to the radar information 711, and controlling to turn on or off a light sensor module 77 of the image capturing device 7 according to the time intervals 721 or the ON/OFF state of an illumination device 82 (such as a head light 42) of a vehicle 8.

The image superimposition module 74 can further be used for superimposing feature regions 7011 in the temporary images 701 to generate at least one superimposed image 741 according to the radar information 711.

And then, the processing module 73 can transmit the at least one superimposed image 741 to the display module 75 for displaying the superimposed image 741. In addition, the processing module 73 can save the at least one superimposed image 741 in the storage module 76.

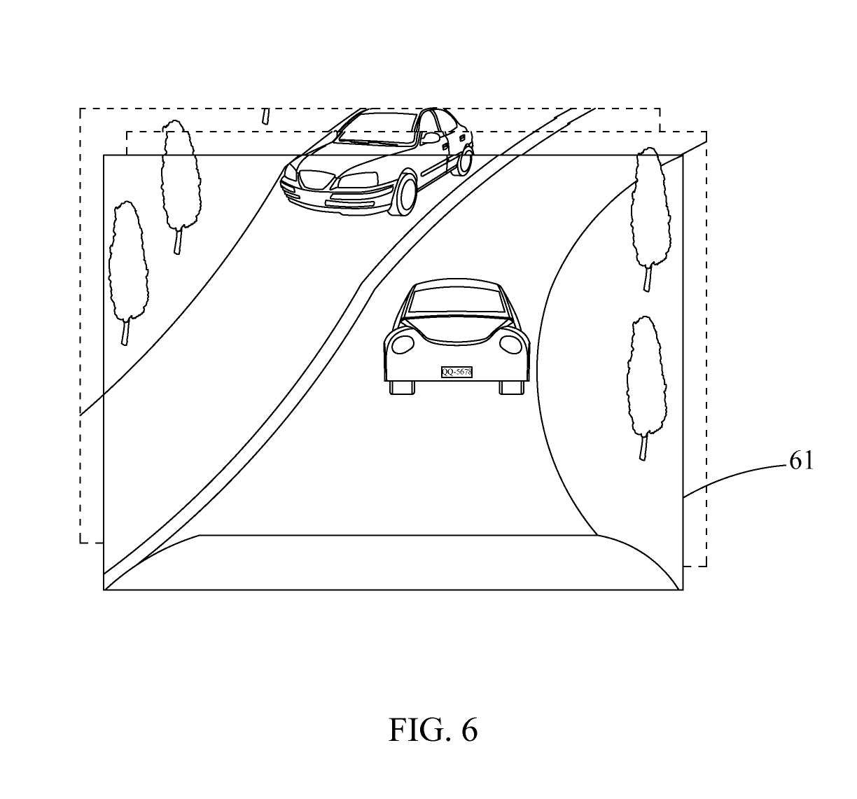

With reference to FIG. 6 for a flow chart of an image superimposition method applied in a vehicle in accordance with the second preferred embodiment of the present invention together with FIG. 5, the image superimposition method of this preferred embodiment is similar to the image superimposition method of at of the first preferred embodiment, and thus will not be described again. However, it is noteworthy to point out that the image capturing device of this preferred embodiment further comprises a receiving module and a setting module, and the method comprises the following steps:
(S91) Use a receiving module to receive radar information.
(S92) Use a setting module to set a plurality of time intervals.
(S93) Use a processing module to dynamically control a sampling time of a plurality of temporary images captured by the image capturing module according to driving information of the vehicle and the radar information, and control to turn on or off a light sensor of the image capturing device according to the time intervals or the ON/OFF state of an illumination device of the vehicle.
(S94) Finally use an image superimposition module to superimpose feature regions in the temporary images to generate at least one superimposed image, if the driving information of the vehicle matches a preset condition and the radar information.

With reference to FIGS. 3, 4 and 5 for an image capturing device applied in a vehicle in accordance with the present invention, before driving, the driver 5 can set the setting module 72 to define two time intervals, respectively a daytime interval and a nighttime interval, and each time interval is equal to 12 hours. If the driver 5 drives the car 4 at a speed less than 40 km/hr in a lane, the processing module 73 need not to turn on the light sensor module 77 since the time interval falls within the daytime interval. Even though the driver 5 is driving in a tunnel and turns on the head light 42, the processing module 73 will not turn on the light sensor module 77 according to the foregoing defined time interval. In addition, the processing module 73 can extend the sampling time of the temporary image 701 captured by the image capturing module 70 from 1/50 second to 1/30 second according to the radar information 711 and the driving speed.

And then, the image superimposition module 74 can reference the car position data of the Global Positioning System (GPS) and the radar information 711 to perform an image superimposition for each pixel of a lane, a car in the front, or a tree with similar features in the temporary images 701 to generate at least one superimposed image 741.

The image superimposition and the processing method of this preferred embodiment are similar to those of the first preferred embodiment, and thus will not be described again.

In summation of the description above, the image capturing device applied in a vehicle and the image superimposition method thereof in accordance with the present invention can reference the driving speed of a car to dynamically adjust the sampling time of the subsequent temporary images according to the quality of the previous temporary image, and select appropriate temporary images and combine similar areas in the temporary images according to the dynamic driving information of the car to determine the required temporary images for the image superimposition. Therefore, the invention can improve the image synthesis result to achieve the effects of enhancing the image brightness and reducing the noises in the images.

What is claimed is:

1. An image capturing device applied in a vehicle, comprising:
an image capturing module;
a processing module, dynamically controlling a sampling time of a plurality of temporary images captured by the image capturing module according to driving information of the vehicle; and
an image superimposition module, for superimposing feature regions in the temporary images to generate at least one superimposed image, if the driving information of the vehicle matches a preset condition.

2. The image capturing device as recited in claim 1, wherein the driving information comprises a driving direction of the vehicle, a U-turn angle of a steering wheel, a driving speed, a shift gear or a position datum of global positioning system (GPS).

3. The image capturing device as recited in claim 2, wherein the preset condition comprises the driving speed being less than a predetermined speed, or the U-turn angle being greater than a predetermined angle, or the shift gear being a reverse gear.

4. The image capturing device as recited in claim 1, wherein the processing module correspondingly shortens or extends the sampling time of each temporary image according to an increase or a decrease of a driving speed of the vehicle.

5. The image capturing device as recited in claim 1, further comprising a setting module for setting a plurality of time intervals, and the processing module correspondingly controlling to turn on or off a light sensor of the image capturing device according to the time intervals or an ON or OFF state of an illumination device of the vehicle.

6. The image capturing device applied in a vehicle as recited in claim 1, further comprising a receiving module, for receiving radar information, and the image superimposition module being provided for superimposing the feature regions in the temporary images to generate the at least one superimposed image according to the radar information.

7. The image capturing device applied in a vehicle as recited in claim 6, wherein the feature regions comprise a lane, a scene or an object.

8. An image superimposition method applied in a vehicle, comprising the steps of:
installing an image capturing module;
using a processing module to dynamically control a sampling time of a plurality of temporary images captured by the image capturing module according to driving information of the vehicle; and
using an image superimposition module to superimpose feature regions in the temporary images to generate at least one superimposed image if the driving information of the vehicle matches a preset condition.

9. The image superimposition method as recited in claim 8, further comprising the steps of:
using a setting module to set a plurality of time intervals; and
using the processing module to correspondingly control to turn on or off a light sensor of the image capturing device according to the time intervals or an ON or OFF state of an illumination device of the vehicle.

10. The image superimposition method as recited in claim 8, further comprising the steps of:
using a receiving module to receive radar information; and
superimposing the feature regions in the temporary images according to the radar information to produce the at least one superimposed image by the image superimposition module.

11. The image superimposition method as recited in claim 10, wherein the feature regions comprise a lane, a scene or an object.

12. The image superimposition method applied in a vehicle as recited in claim 8, further comprising the step of shortening or extending the sampling time of each temporary image according to an increase or a decrease of a driving speed of the vehicle.

13. The image superimposition method as recited in claim 8, wherein the driving information comprises a driving direction of the vehicle, a U-turn angle of a steering wheel, a driving speed, a shift gear or a position datum of global positioning system (GPS).

14. The image superimposition method as recited in claim 13, wherein the preset condition comprises the driving speed being less than a predetermined speed, or the U-turn angle being greater than a predetermined angle, or the shift gear being a reverse gear.

15. An image capturing device applied in a vehicle, comprising:
an image capturing module;
a receiving module, for receiving radar information;
a setting module, for setting a plurality of time intervals;
a processing module, dynamically controlling a sampling time of a plurality of temporary images captured by the image capturing module according to driving information of the vehicle; and
an image superimposition module, for superimposing feature regions in the temporary images to generate at least one superimposed image, if the driving information of the vehicle matches a preset condition and the radar information.

16. The image capturing device, as recited in claim 15, wherein the driving information comprises a driving direction of the vehicle, a U-turn angle of a steering wheel, a driving speed, a shift gear or a position datum of global positioning system (GPS).

17. The image capturing device, as recited in claim 16, wherein the preset condition comprises the driving speed being less than a predetermined speed, or the U-turn angle being greater than a predetermined angle, or the shift gear being a reverse gear.

18. The image capturing device, as recited in claim 15, wherein the processing module shortens or extends the sampling time of each temporary image according to an increase or a decrease of a driving speed of the vehicle.
